(19) United States
(12) Patent Application Publication
(10) Pub. No.: US 2026/0276421 A1
(43) Pub. Date: Sep. 17, 2026

(54) APPARATUS, METHOD, AND NON-TRANSITORY COMPUTER READABLE MEDIUM

(71) Applicant: Yokogawa Electric Corporation, Tokyo (JP)

(72) Inventors: Ryousuke NOMURA, Tokyo (JP); Moe GOTO, Tokyo (JP); Kazutoshi OKAMOTO, Tokyo (JP); Atsushi ISHINABE, Tokyo (JP); Yuichi HAYASHI, Tokyo (JP)

(21) Appl. No.: 19/166,864

(22) PCT Filed: Jan. 24, 2024
(86) PCT No.: PCT/JP2024/002072

§ 371 Date: Sep. 18, 2025

(30) Foreign Application Priority Data
Mar. 29, 2023 (JP) 2023-052768

(51) Int. Cl. G01F 1/74; G01F 1/32

(52) U.S. Cl. CPC G01F 1/74; G01F 1/3209

(57) ABSTRACT

Provided is an apparatus including: a measurement value acquisition unit which acquires a plurality of measurement values regarding fluid; a state determination estimation unit which estimates a state of the fluid on the basis of at least one of the plurality of acquired measurement values; a fluid quality estimation unit which estimates at least one of a liquid amount or dryness regarding the fluid from at least one of the plurality of acquired measurement values according to the estimated state of the fluid; and an output unit which outputs the estimated at least one of the liquid amount or the dryness.

### TECHNICAL FIELD

The present invention relates to an apparatus, a method, and a program.

The contents of the following patent application(s) are incorporated herein by reference: NO. 2023-052768 filed in JP on Mar. 29, 2023

### BACKGROUND

Patent Document 1 describes that “a method for measuring the degree of wetness, in which the flow rate of wet vapor circulating through a pipe is measured by one of a vortex flow meter or an ultrasonic flow meter and an orifice flow meter, and the degree of wetness in the pipe is acquired using values measured by the flow meters”. Patent Document 2 describes that “a vortex flow measuring apparatus, which, while in use, as a rule, can measure the flow velocity of the first phase of a flowable two or more phase medium using a vortex frequency of the Karman vortices registered by the vortex sensor, and also simultaneously detect the occurrence of at least a second phase in the form of a distributed particle and/or droplet flow near in time (that is, online). Patent Document 3 describes that “during use of the vortex flow measuring apparatus, on the basis of the standard deviation or kurtosis decided from the measurement signal as well as the vortex frequency, and referencing the correlation, the mass flow rate of the wall flow of the second phase can then be quantitatively measured in a simple method”.

### RELATED ART DOCUMENTS

### Patent Documents

Patent Document 1: Japanese Patent Application Publication No. 2013-185915

Patent Document 2: Japanese U.S. Pat. No. 5,443,514

Patent Document 3: Japanese U.S. Pat. No. 5,355,724

### GENERAL DISCLOSURE

A first aspect of the present invention provides an apparatus including: a measurement value acquisition unit which acquires a plurality of measurement values regarding fluid; a state determination estimation unit which estimates a state of the fluid on the basis of at least one of the plurality of acquired measurement values; a fluid quality estimation unit which estimates at least one of a liquid amount or dryness regarding the fluid from at least one of the plurality of acquired measurement values according to the estimated state of the fluid; and an output unit which outputs the estimated at least one of the liquid amount or the dryness.

The above apparatus may further include a selection unit which selects a computation corresponding to the estimated state of the fluid from a plurality of computations, and the fluid quality estimation unit may estimate, by the selected computation, the at least one of the liquid amount or the dryness regarding the fluid from at least one of the plurality of acquired measurement values. The selection unit may select different computations according to the fluid flow regime estimated by the state determination estimation unit.

In any of the above apparatuses, the state determination estimation unit may estimate whether the state of the fluid is a stratified flow, a stratified wavy flow, or an annular mist flow, on the basis of at least one of the plurality of acquired measurement values.

In the above apparatus, the state determination estimation unit may determine whether the state of the fluid is wet vapor, on the basis of at least one of the plurality of acquired measurement values, and if it is determined that the state of the fluid is wet vapor, estimate whether the state of the fluid is a stratified flow, a stratified wavy flow, or an annular mist flow, on the basis of at least one of the plurality of acquired measurement values.

In the above apparatus, when a measurement value of a temperature of the fluid exceeds a boiling point of the fluid based on a measurement value of a pressure of the fluid acquired by the measurement value acquisition unit, the state determination estimation unit may determine that the state of the fluid is not wet vapor, and if the state determination estimation unit determines that the state of the fluid is not wet vapor, the fluid quality estimation unit may estimate that the liquid amount regarding the fluid is 0 or the dryness regarding the fluid is 100%.

In any of the above apparatuses, the state determination estimation unit may estimate the state of the fluid on the basis of at least one of the plurality of acquired measurement values by using a first model for estimating the state of the fluid from at least one of the plurality of measurement values regarding the fluid.

In any of the above apparatuses, the fluid quality estimation unit may estimate the at least one of the liquid amount or the dryness regarding the fluid from at least one of the plurality of acquired measurement values by using a second model for estimating the at least one of the liquid amount or the dryness regarding the fluid from at least one of the plurality of measurement values regarding the fluid according to the estimated state of the fluid. The selection unit may select one second model corresponding to the estimated state of the fluid from a plurality of second models for estimating the at least one of the liquid amount or the dryness regarding the fluid from at least one of the plurality of measurement values regarding the fluid.

Any of the above apparatuses may further include a learning processing unit which generates, for each state of the fluid, the second model for estimating the at least one of the liquid amount or the dryness regarding the fluid from at least one of the plurality of measurement values regarding the fluid.

In any of the above apparatuses, the measurement value acquisition unit may acquire, as the plurality of measurement values regarding the fluid, at least one of a flow velocity, a temperature, a pressure, a viscosity, a concentration, a density, a signal amplitude, or a vortex frequency measured for the fluid.

In any of the above apparatuses, the measurement value acquisition unit may acquire the plurality of measurement values regarding the fluid from a vortex flow meter. The second model may be a regression model for outputting the dryness or the liquid amount according to an input of at least one of a signal strength, a density, or a vortex frequency measured with the vortex flow meter.

A second aspect of the present invention provides a method including: acquiring, by a computer, a plurality of measurement values regarding fluid; estimating, by the computer, a state of the fluid on the basis of at least one of the plurality of acquired measurement values; estimating, by the computer, at least one of a liquid amount or dryness regarding the fluid from at least one of the plurality of acquired measurement values according to the estimated state of the fluid; and outputting, by the computer, the estimated at least one of the liquid amount or the dryness.

A third aspect of the present invention provides a program that causes a computer to function as: a measurement value acquisition unit which acquires a plurality of measurement values regarding fluid; a state determination estimation unit which estimates a state of the fluid on the basis of at least one of the plurality of acquired measurement values; a fluid quality estimation unit which estimates at least one of a liquid amount or dryness regarding the fluid from at least one of the plurality of acquired measurement values according to the estimated state of the fluid; and an output unit which outputs the estimated at least one of the liquid amount or the dryness.

The summary clause does not necessarily describe all necessary features of the embodiments of the present invention. The present invention may also be a sub-combination of the features described above.

### BRIEF DESCRIPTION OF THE DRAWINGS

FIG. 1 is an example of a block diagram illustrating a system 10 according to the present embodiment.

FIG. 2 is an explanatory diagram for explaining a flow regime of a fluid in a pipe.

FIG. 3 is a flow diagram illustrating an example of an operation of a processing apparatus 30 according to the present embodiment.

FIG. 4 is an explanatory diagram for explaining an example of a first model.

FIG. 5 is an explanatory diagram for explaining an example of a second model.

FIG. 6 illustrates an example of a computer 2200 in which a plurality of aspects of the present invention may be embodied in whole or in part.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

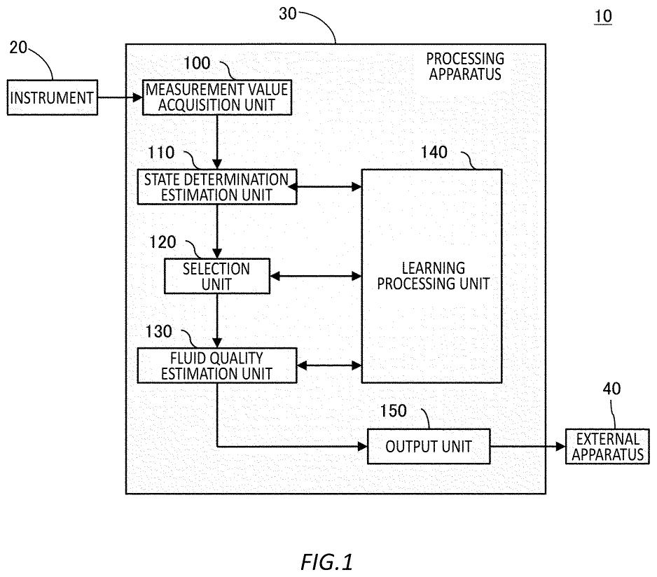

FIG. 1 is an example of a block diagram illustrating a system 10 according to the present embodiment. Note that, these blocks are functional blocks that are each functionally divided, and may not be necessarily required to be matched with actual apparatus configurations. That is, in the present drawing, an apparatus indicated by one block may not be necessarily required to be configured by one apparatus. In addition, in the present drawing, apparatuses indicated by separate blocks may not be necessarily required to be configured by separate apparatuses. The same applies to subsequent block diagrams.

The system 10 collects data from an instrument 20 installed in a facility such as a plant. Examples of the plant may include a plant for managing and controlling wells such as a gas field and an oil field and surroundings thereof, a plant for managing and controlling hydroelectric, thermo electric and nuclear power generations and the like, a plant for managing and controlling environmental power generation such as solar power and wind power, a plant for managing and controlling water and sewerage, a dam, and the like, etc., in addition to chemical and bio industrial plants and the like. The system 10 includes one or more instruments 20, a processing apparatus 30, and an external apparatus 40.

The one or more instruments 20 are connected to the processing apparatus 30 in a wired or wireless manner. At least one of the one or more instruments 20 may be a field instrument, and as an example, is a vortex flow meter which measures a flow rate by measuring a vortex generated in fluid. In addition, the instrument 20 may be, for example, a pressure sensor, a flow meter, a temperature sensor, a densitometer, a viscometer, a concentration meter, or the like. The instrument 20 may transmit, to the processing apparatus 30, measurement values regarding the fluid flowing in the pipes of the facility.

The processing apparatus 30 is connected to an external apparatus 40. The processing apparatus 30 may be a computer such as a personal computer (PC), a tablet computer, a smartphone, a workstation, a server computer, or a general-purpose computer, or may be a computer system in which a plurality of computers is connected. In addition, the processing apparatus 30 may be an internal computer of a field instrument such as a vortex flow meter. Such a computer system is also a computer in a broad sense. In addition, the processing apparatus 30 may also be implemented by one or more virtual computer environments executable in a computer.

The processing apparatus 30 estimates at least one of the liquid amount or the dryness of the fluid on the basis of the measurement value regarding the fluid acquired from one or more instruments 20. The processing apparatus 30 includes a measurement value acquisition unit 100, a state determination estimation unit 110, a selection unit 120, a fluid quality estimation unit 130, a learning processing unit 140, and an output unit 150.

Here, the fluid in the present embodiment may contain at least one of gas (vapor) into which water or the like is evaporated or liquid into which gas is condensed. In addition, the estimated liquid amount indicates, for example, the mass occupied by the liquid condensed in the vapor. The dryness to be estimated indicates, for example, a ratio of a mass of gas vapor to a mass of vapor.

The measurement value acquisition unit 100 is connected to one or more instruments 20 and the state determination estimation unit 110. The measurement value acquisition unit 100 acquires a plurality of measurement values regarding the fluid from the instrument 20. The measurement value acquisition unit 100 may acquire a plurality of different types of measurement values measured by one instrument 20, or may acquire a plurality of measurement values measured by a plurality of instruments 20 respectively.

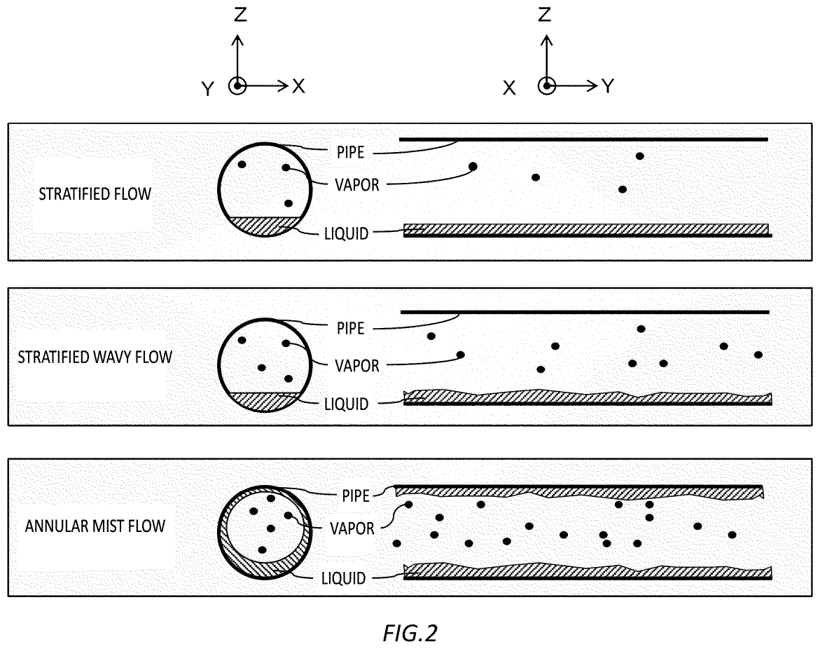

The state determination estimation unit 110 is connected to the learning processing unit 140 and the selection unit 120. The state determination estimation unit 110 estimates the state of the fluid on the basis of at least one of the plurality of measurement values acquired by the measurement value acquisition unit 100. The state determination estimation unit 110 may estimate, as the state of the fluid, the flow regime of the fluid in the pipe on the basis of the measurement value. Note that the flow regime will be described later with reference to FIG. 2. By using a first model for estimating the state of the fluid from at least one of the plurality of measurement values regarding the fluid, the state determination estimation unit 110 may estimate the state of the fluid on the basis of at least one of the plurality of measurement values acquired by the measurement value acquisition unit 100.

The selection unit 120 is connected to the learning processing unit 140 and the fluid quality estimation unit 130. The selection unit 120 selects a computation corresponding to the estimated state of the fluid from a plurality of computations. The selection unit 120 may select a computation different depending on the flow regime of the fluid. The selection unit 120 may select one second model corresponding to the state of the fluid from a plurality of second models for estimating the at least one of the liquid amount or the dryness regarding the fluid from at least one of the plurality of measurement values regarding the fluid.

The fluid quality estimation unit 130 is connected to the learning processing unit 140 and the output unit 150. The fluid quality estimation unit 130 estimates the at least one of the liquid amount or the dryness regarding the fluid from at least one of the plurality of measurement values acquired by the measurement value acquisition unit 100 according to the state of the fluid estimated by the state determination estimation unit 110. The fluid quality estimation unit 130 may estimate the at least one of the liquid amount or the dryness regarding the fluid from at least one of the plurality of measurement values acquired by the measurement value acquisition unit 100 by the computation selected by the selection unit 120. The fluid quality estimation unit 130 may estimate the at least one of the liquid amount or the dryness regarding the fluid from at least one of the plurality of measurement values acquired by the measurement value acquisition unit 100 by using the second model for estimating the at least one of the liquid amount or the dryness regarding the fluid from at least one of the plurality of measurement values regarding the fluid according to the state of the fluid estimated by the state determination estimation unit 110. The fluid quality estimation unit 130 can calculate, from the estimation result of one of the dryness and the liquid amount, the other by using the flow rate of the vapor of the fluid.

The learning processing unit 140 performs learning processing on a plurality of models used in the processing apparatus 30. The learning processing unit 140 generates, for each state of the fluid, the second model for estimating the at least one of the liquid amount or the dryness regarding the fluid from at least one of the plurality of measurement values regarding the fluid. The learning processing unit 140 may generate the first model for estimating the state of the fluid from at least one of the plurality of measurement values regarding the fluid.

The output unit 150 is connected to the external apparatus 40. The output unit 150 outputs, to the external apparatus 40, the at least one of the liquid amount or the dryness estimated by the fluid quality estimation unit 130.

The external apparatus 40 may be a display apparatus which displays the estimation result of the processing apparatus 30, a PC which stores the estimation result of the processing apparatus 30, or the like.

FIG. 2 is an explanatory diagram for explaining the flow regime of the fluid in the pipe. FIG. 2 shows an XZ cross section and a YZ cross section in the pipe for each of a stratified flow, a stratified wavy flow, and an annular mist flow, which are flow regimes. In FIG. 2, the fluid flows in a Y axis direction in the pipe.

For example, the fluid containing evaporated water has three flow states (flow regimes) in a state of wet vapor in which liquid water is mixed with gas vapor. In the stratified flow, the liquid flows gently at the bottom of the pipe. In the stratified wavy flow, the liquid flows while creating waves at the bottom of the pipe. In the annular mist flow, the liquid flows in contact with the entire circumference of the inner wall of the pipe, and the number of droplets mixed with the vapor increases. Such a flow regime varies depending on the gas flow velocity and the moisture degree of the fluid. The three flow regimes differ in the state of a Karman vortex in the measurement of the vortex flow meter and a sensor signal for detecting a vortex, and also differ in the influence on the measurement regarding the fluid. For such a state of the fluid, the same applies to fluids other than the evaporated water.

Therefore, in the present embodiment, the liquid amount or the dryness of the fluid, which is an indicator of vapor quality, is estimated by computation corresponding to the state of the fluid.

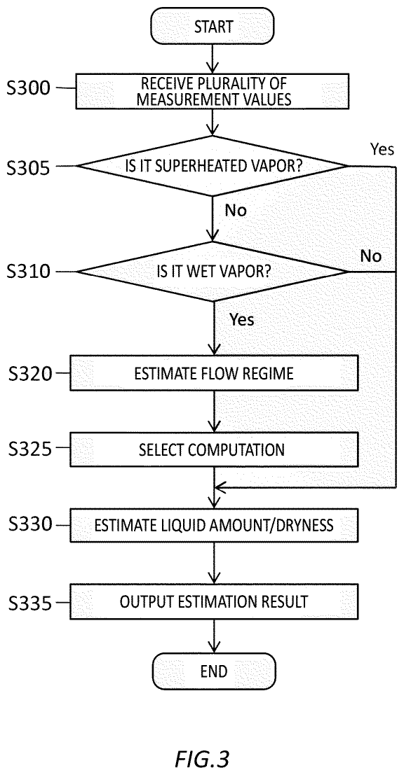

FIG. 3 is a flow diagram illustrating an example of an operation of the processing apparatus 30 according to the present embodiment. In the embodiment of FIG. 3, the instrument 20 is, as an example, a vortex flow meter.

The vortex flow meter has a detection unit through which fluid to be measured flows, and when the fluid has a certain flow velocity or higher, a vortex called the Karman vortex is generated downstream of a vortex generator in the detection unit. The Karman vortices are alternately generated on the left and right sides (or upper and lower sides) around the axis of the vortex generator, and a pressure in the fluid changes due to the vortex generation. Two piezoelectric elements are arranged inside the vortex generator, and the two piezoelectric elements detect the pressure caused by the vortex generation and also have a function of canceling external vibration transmitting through a pipe or the like through which fluid flows. The vortex flow meter can measure, as pressure fluctuation, the generation cycle of the Karman vortex by the two piezoelectric elements to acquire the volumetric flow rate of the fluid. In addition, a temperature sensor such as a resistance temperature detector and an internal sensor such as a pressure sensor are arranged inside the detection unit, and the temperature and the pressure of the fluid are measured. The vortex flow meter can also measure a fluid temperature from the internal sensor and a fluid pressure from the pressure sensor, determine a density from the temperature and the pressure of the fluid, and calculate a mass flow rate (volumetric flow rate x density). In addition, the vortex flow meter can also detect the influence of vortex generation on a sound velocity with an ultrasonic sensor or an optical sensor. The vortex flow meter may transmit, to the processing apparatus 30, a plurality of measurement values acquired as described above.

In step S300, the measurement value acquisition unit 100 acquires, as the plurality of measurement values regarding the fluid, at least one of the flow velocity, the temperature, the pressure, the viscosity, the concentration, the density, the signal amplitude, or the vortex frequency measured for the fluid by the instrument 20. The measurement value acquisition unit 100 may acquire the plurality of measurement values measured or calculated by the vortex flow meter which is the instrument 20. In addition, the measurement value acquisition unit 100 may acquire the measurement value measured by the vortex flow meter and calculate a measurement value such as the volumetric flow rate or the mass flow rate of the fluid. The measurement value acquisition unit 100 may acquire, as a measurement value, at least one of the flow velocity obtained from the vortex frequency, the signal amplitude detected by the two piezoelectric elements of the vortex generator, or a frequency component from the vortex flow meter, for example, and the processing apparatus 30 may use the measurement value for state estimation and parameter estimation in the following steps. By using these measurement values, it is possible to improve the accuracy of state estimation regarding the fluid and the accuracy of estimation of the liquid amount or the dryness.

The measurement value acquisition unit 100 may output, to the state determination estimation unit 110 and the fluid quality estimation unit 130, a plurality of measurement values acquired simultaneously or in the same cycle in association with each other. In the following steps, the state determination estimation unit 110 and the fluid quality estimation unit 130 may perform estimation for each set in which the plurality of measurement values acquired simultaneously or in the same cycle by the measurement value acquisition unit 100 are associated with each other.

In step S305, the state determination estimation unit 110 determines whether the state of the fluid is superheated vapor, on the basis of the measurement value of the fluid acquired by the measurement value acquisition unit 100. The state determination estimation unit 110 may determine whether the state of the fluid is superheated vapor by comparing the measurement value of the fluid acquired by the measurement value acquisition unit 100 with a threshold. When the measurement value of the temperature of the fluid exceeds the boiling point of the fluid (the boiling point of the liquid contained in the fluid) based on the measurement value of the pressure of the fluid acquired by the measurement value acquisition unit 100, the state determination estimation unit 110 may determine that the state of the fluid is superheated vapor (that is, not wet vapor). For example, the state determination estimation unit 110 may acquire the boiling point corresponding to the measurement value of the pressure of the fluid from the vapor curve of the liquid in the fluid, and when the measurement value of the temperature of the fluid exceeds the boiling point, determine that the fluid is superheated vapor. In such a case where the measurement value of the temperature of the fluid exceeds the boiling point of the fluid, the processing apparatus 30 may proceed to step S330, and when the measurement value of the temperature of the fluid is equal to or less than the boiling point of the fluid, the processing apparatus 30 may proceed to step S310.

In step S310, the state determination estimation unit 110 determines whether the state of the fluid is wet vapor, on the basis of the measurement value of the fluid acquired by the measurement value acquisition unit 100. By using a wet vapor determination model for estimating whether the fluid is wet vapor from at least one of the plurality of measurement values regarding the fluid, the state determination estimation unit 110 may determine whether the fluid is wet vapor, on the basis of at least one of the plurality of measurement values. The wet vapor determination model may be a model for outputting the determination result, such as a logistic regression, a neural network, a support vector machine, a classification tree, change point detection, a k-nearest neighbor algorithm, or a k-means algorithm.

In addition, when the measurement value of the temperature of the fluid acquired by the measurement value acquisition unit 100 is less than the boiling point of the fluid, the state determination estimation unit 110 may determine that the state of the fluid is wet vapor (that is, not superheated vapor). In this case, the state determination estimation unit 110 may determine the state of the fluid by using a vapor curve.

In steps S305 and S310, the state determination estimation unit 110 determines whether the state of the fluid is wet vapor, on the basis of at least one of the plurality of measurement values acquired by the measurement value acquisition unit 100. If the state determination estimation unit 110 determines, in step S305, that the fluid is not superheated vapor and determines, in step S310, that the fluid is wet vapor, the process may proceed to step S320, and if the state determination estimation unit determines that the fluid is not wet vapor, the process may proceed to step S330.

In step S320, if it is determined in steps S305 and S310 that the state of the fluid is wet vapor, the state determination estimation unit 110 estimates whether the state of the fluid is a stratified flow, a stratified wavy flow, or an annular mist flow, on the basis of at least one of the plurality of measurement values acquired by the measurement value acquisition unit 100. The state determination estimation unit 110 may estimate the flow regime of the fluid by using the first model for estimating the state of the fluid from at least one of the plurality of measurement values regarding the fluid. The first model may be a classification model, and may be a model such as a logistic regression, a neural network, a support vector machine, a classification tree, change point detection, a k-nearest neighbor algorithm, or a k-means algorithm.

In step S325, the selection unit 120 selects a computation corresponding to the state of the fluid estimated by the state determination estimation unit 110 from a plurality of computations for estimating at least one of the liquid amount or the dryness. The selection unit 120 may select the second model corresponding to the state of the fluid from the plurality of second models for estimating the at least one of the liquid amount or the dryness. The selection unit 120 may select the second model corresponding to the flow regime of the fluid estimated by the state determination estimation unit 110, from the second model corresponding to the stratified flow, the second model corresponding to the stratified wavy flow, or the second model corresponding to the annular mist flow. The plurality of second models may be generated by learning processing for each corresponding flow regime, and may be different from each other. The selection unit 120 may store the plurality of second models generated in advance by the learning processing unit 140.

The second model may be a regression model, and may be a model such as multiple regression analysis, a neural network, a support vector regression, a Gaussian process regression, a regression tree, an autoregressive model, a logistic regression, a classification tree, change point detection, a k-nearest neighbor algorithm, or a k-means algorithm. The neural network may include a convolutional neural network, a recursive neural network, or a long/short storage neural network. Since the signal strength, the density, and the vortex frequency of the piezoelectric element measured by the vortex flow meter are correlated with the dryness or the liquid amount, the second model may be a regression model for outputting the dryness or the liquid amount at least according to the input of at least one of the signal strength, the density, or the vortex frequency. As an example, since there is a correlation between the flow rate of the fluid calculated from at least one of the signal strength, the density, or the vortex frequency acquired from the vortex flow meter and the dryness or the liquid amount of the fluid, the second model may output the dryness or the liquid amount of the fluid by using, as an input, at least one of the signal strength, the density, or the vortex frequency acquired from the vortex flow meter. Note that the second model may be generated by learning processing by using, as training data, a plurality of measurement values (for example, at least one of the signal strength, the density, or the vortex frequency) regarding the fluid and using, as teacher data, the dryness or the liquid amount corresponding to the plurality of measurement values.

In step S330, the fluid quality estimation unit 130 estimates the at least one of the liquid amount or the dryness regarding the fluid. The fluid quality estimation unit 130 may use, as an estimation result, the at least one of the liquid amount or the dryness output in response to inputting the plurality of measurement values to the second model selected by the selection unit 120. The fluid quality estimation unit 130 may, to the second model, input all types of measurement values acquired by the measurement value acquisition unit 100, or may input, to the second model, a predetermined type of measurement value among the plurality of measurement values acquired by the measurement value acquisition unit 100. The fluid quality estimation unit 130 may estimate one of the liquid amount and the dryness and calculate the other of the liquid amount and the dryness from the estimated one.

If the state determination estimation unit 110 determines, in step S305 or S310, that the state of the fluid is not wet vapor, the fluid quality estimation unit 130 may estimate that the liquid amount regarding the fluid is 0 or the dryness regarding the fluid is 100%. Since the state determination estimation unit 110 determines that the fluid is superheated vapor or not wet vapor, the fluid quality estimation unit 130 may use the liquid amount of 0 or the dryness of 100% as the estimation result. In this case, the fluid quality estimation unit 130 may calculate, as the estimation result regarding the fluid, the enthalpy or the heat quantity of the superheated vapor from the plurality of measurement values.

In step S335, the output unit 150 outputs the estimation result of the fluid quality estimation unit 130 to the external apparatus 40. The output unit 150 may output display data for displaying the estimation result on the external apparatus 40. In addition, the output unit 150 may output data for notifying a user of the estimation result by an alarm or the like of the external apparatus 40. As an example, the output unit 150 may output the data to be notified to the user by an alarm of the external apparatus 40 when the liquid amount or the dryness as the estimation result exceeds a predetermined threshold or is equal to or less than the predetermined threshold. The predetermined threshold may be set in advance by the user or the like. In addition, the output unit 150 may output, to the external apparatus 40, control data for performing the control of a plant corresponding to the estimation result, and the external apparatus 40 may control the plant according to the control data.

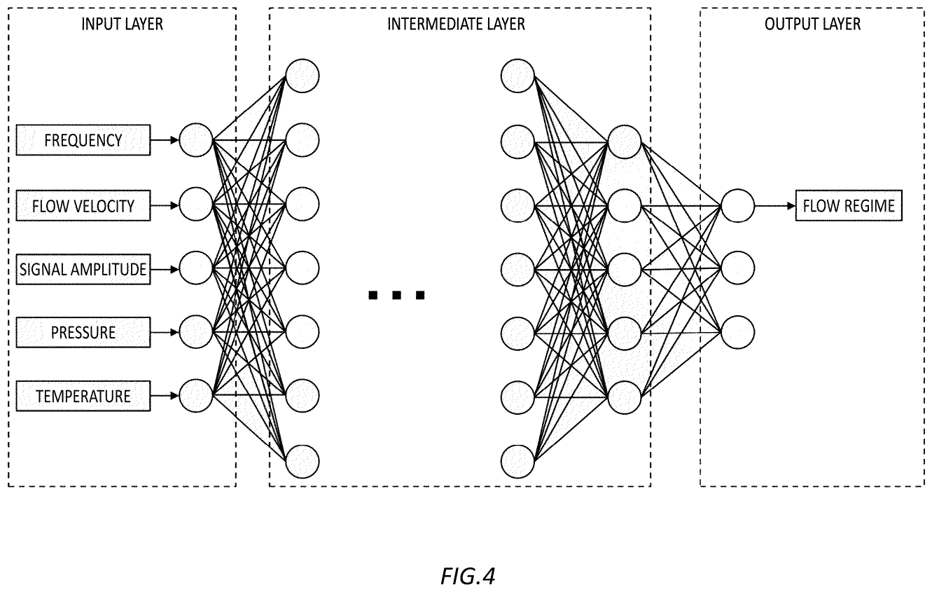

FIG. 4 is an explanatory diagram for explaining an example of the first model. In the example of FIG. 4, the first model is a model of a neural network, and each node is represented by a circle. In the first model, the measurement value (the Vortex frequency, the flow velocity, the signal amplitude, the pressure, and the temperature), which is acquired by the measurement value acquisition unit 100 from the vortex flow meter and other sensors, regarding the fluid is input to each node of an input layer, and the estimation result of the flow regime of the fluid is output to the node of an output layer. Three nodes of the output layer are a node to which a calculation result (for example, a probability that the fluid is the stratified flow) for the stratified flow is output, a node to which a calculation result (for example, a probability that the fluid is the stratified wavy flow) for the stratified wavy flow is output, and a node to which a calculation result (for example, a probability that the fluid is the annular mist flow) for the annular mist flow is output, respectively.

An arbitrary number of layers and an arbitrary number of neurons may be set in the intermediate layer of the first model. A general nonlinear function such as a ramp function, a sigmoid function, or a hyperbolic tangent function may be set as the activation function of the first model. From the viewpoint of an error backpropagation method, the output layer may be provided with a softmax function at the time of multi-value classification.

In the first model, in response to the input of the measurement value to the input layer, the calculation result corresponding to the weight assigned between the nodes of the intermediate layer may be output to the node of the output layer, and the state determination estimation unit 110 may output, as the state of the fluid, a flow regime having the highest probability. Note that the state determination estimation unit 110 may normalize each measurement value to a predetermined range and input the normalized value to each node of the input layer. For the measurement value, the learning processing unit 140 may perform learning processing by using, as training data, a data group of a plurality of measurement values and using, as teacher data, a flow regime regarding the measurement values, and optimize the weight to generate the first model. The plurality of measurement values in each flow regime used by the learning processing unit 140 may be data obtained in advance by experiments, simulations, plant operations, or the like.

The first model may have at least one node of the input layer, and all or some of the plurality of measurement values regarding the fluid acquired by the measurement value acquisition unit 100 may be input to the node of the input layer. In addition, the wet vapor determination model may be a model similar to the first model, and may be subjected to learning processing similar to that of the first model.

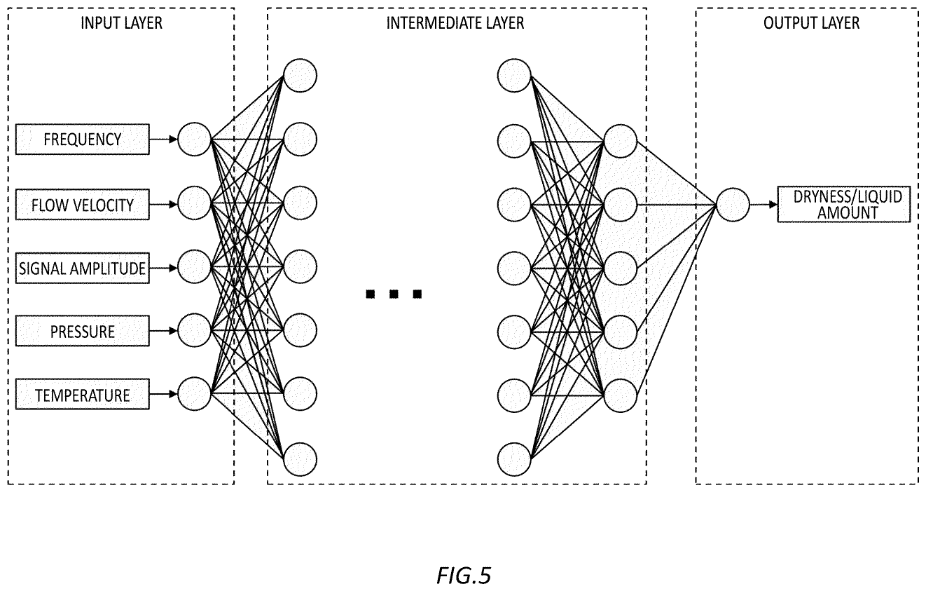

FIG. 5 is an explanatory diagram for explaining an example of the second model. In the example of FIG. 5, the second model is a model of a neural network, and each node is represented by a circle. In the second model, the measurement value (the Vortex frequency, the flow velocity, the signal amplitude, the pressure, and the temperature), which is acquired by the measurement value acquisition unit 100 from the vortex flow meter and other sensors, regarding the fluid is input to each node of the input layer, and the liquid amount or the dryness of the fluid is output to the node of the output layer. An arbitrary number of layers and an arbitrary number of neurons may be set in the intermediate layer of the second model. A general nonlinear function such as a ramp function, a sigmoid function, or a hyperbolic tangent function may be set as the activation function of the second model. From the viewpoint of an error backpropagation method, the output layer may be provided with a softmax function at the time of multi-value classification.

In the second model, in response to the input of the measurement value to the input layer, the calculation result (liquid amount or dryness) corresponding to the weight assigned between the nodes of the intermediate layer is output to the node of the output layer, and the fluid quality estimation unit 130 may output the output liquid amount or dryness as the estimation result. Note that the fluid quality estimation unit 130 may normalize each measurement value to a predetermined range and input the normalized value to each node of the input layer. The learning processing unit 140 may perform learning processing by using, as training data, a data group of a plurality of measurement values obtained for each flow regime, and optimize the weight to generate the second model. The learning processing unit 140 may generate the second model corresponding to the stratified flow by using, as training data, a plurality of measurement values when the fluid is the stratified flow. The learning processing unit 140 may generate the second model corresponding to the stratified wavy flow by using, as training data, a plurality of measurement values when the fluid is the stratified wavy flow. The learning processing unit 140 may generate the second model corresponding to the annular mist flow by using, as training data, a plurality of measurement values when the fluid is the annular mist flow. The plurality of measurement values in each flow regime used by the learning processing unit 140 may be data obtained in advance by experiments, simulations, plant operations, or the like.

The second model may have at least one node of the input layer, and all or some of the plurality of measurement values regarding the fluid acquired by the measurement value acquisition unit 100 may be input to the node of the input layer.

The processing apparatus 30 according to the present embodiment can estimate the state of the fluid and estimate the liquid amount or the dryness by using the model corresponding to the state of the fluid, so that an estimation accuracy is high.

The fluid quality estimation unit 130 may perform computation by using a function or a table that defines a relationship between the measurement value and the liquid amount or the dryness.

In addition, the processing apparatus 30 may not include the learning processing unit 140, and the processing apparatus 30 may store in advance a first model generated by an external learning apparatus for estimating the state of the fluid from at least one of the plurality of measurement values regarding the fluid and a second model generated by an external learning apparatus for estimating the at least one of the liquid amount or the dryness regarding the fluid from at least one of the plurality of measurement values regarding the fluid according to the estimated state of the fluid. In this case, the state determination estimation unit 110 may estimate the state of the fluid by using the stored first model, and the fluid quality estimation unit 130 may estimate the at least one of the liquid amount or the dryness by using the stored second model. The learning apparatus is only required to include at least the learning processing unit 140 of the present embodiment. The learning apparatus may be included in a computer such as a PC or an external apparatus such as a cloud.

Various embodiments of the present invention may be described with reference to flowcharts and block diagrams whose blocks may represent (1) steps of processes in which operations are performed or (2) sections of apparatuses responsible for performing operations. Certain steps and sections may be implemented by a dedicated circuit, programmable circuitry supplied with computer readable instructions stored on computer readable media, and/or processors supplied with computer readable instructions stored on computer readable media. The dedicated circuitry may include a digital and/or analog hardware circuit, or may include an integrated circuit (IC) and/or a discrete circuit. Programmable circuitry may include reconfigurable hardware circuits including logical AND, OR, XOR, NAND, NOR, and other logical operations, flip-flops, registers, memory elements, etc., such as field-programmable gate arrays (FPGA), programmable logic arrays (PLA), etc.

Computer readable media may include any tangible device that can store instructions for execution by a suitable device, such that the computer readable medium having instructions stored therein comprises an article of manufacture including instructions which can be executed to create means for performing operations specified in the flowcharts or block diagrams. Examples of the computer readable medium may include an electronic storage medium, a magnetic storage medium, an optical storage medium, an electromagnetic storage medium, a semiconductor storage medium, and the like. More specific examples of computer readable media may include a floppy (registered trademark) disk, a diskette, a hard disk, a random access memory (RAM), a read only memory (ROM), an erasable programmable read only memory (EPROM or Flash memory), an electrically erasable programmable read only memory (EEPROM), a static random access memory (SRAM), a compact disc read only memory (CD-ROM), a digital versatile disk (DVD), a BLU-RAY (registered trademark) disc, a memory stick, an integrated circuit card, etc.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

The computer-readable instruction may be provided for a processor of a general-purpose computer, a special purpose computer, or another programmable processing apparatus, or a programmable circuit locally or via a local area network (LAN) or a wide area network (WAN) such as the Internet, and the computer-readable instruction may be executed to create means for executing the operations designated in the flowcharts or block diagrams. Examples of the processor include a computer processor, a processing unit, a microprocessor, a digital signal processor, a controller, a microcontroller, and the like.

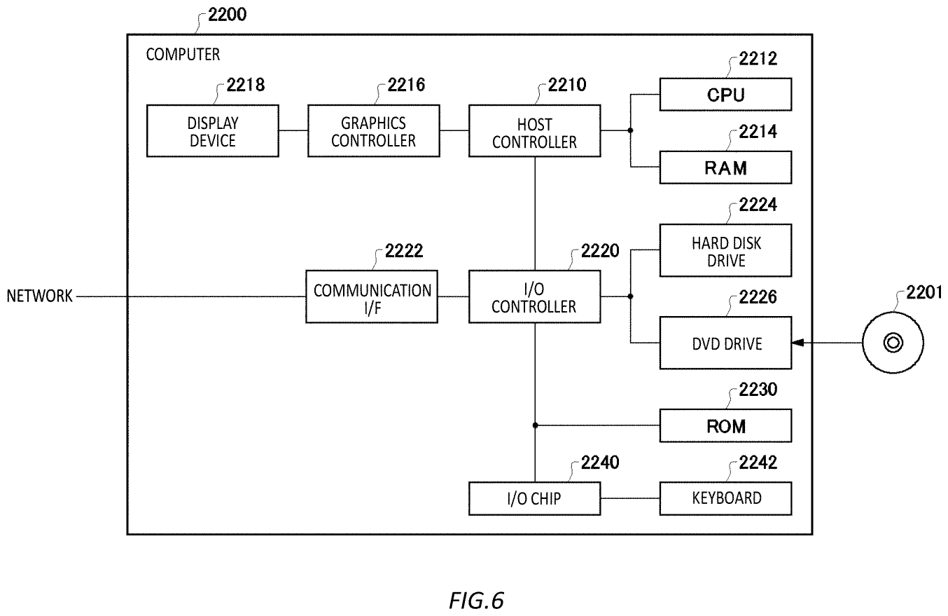

FIG. 6 illustrates an example of a computer 2200 through which a plurality of aspects of the present invention may be entirely or partially embodied. A program that is installed in the computer 2200 can cause the computer 2200 to function as or execute operations associated with an apparatus according to the embodiments of the present invention or one or more sections thereof, or execute the operations or the one or more sections, and/or cause the computer 2200 to execute a process according to the embodiments of the present invention or steps of the process. Such a program may be executed by the CPU 2212 to cause the computer 2200 to execute certain operations associated with some or all of the blocks of flowcharts and block diagrams described herein.

The computer 2200 according to this embodiment includes a CPU 2212, a RAM 2214, a graphics controller 2216, and a display device 2218, which are mutually connected by a host controller 2210. The computer 2200 also includes input/output units such as a communication interface 2222, a hard disk drive 2224, a DVD-ROM drive 2226 and an IC card drive, which are connected to the host controller 2210 via an input/output controller 2220. The computer also includes legacy input/output units such as a ROM 2230 and a keyboard 2242, which are connected to the input/output controller 2220 via an input/output chip 2240.

The CPU 2212 operates according to programs stored in the ROM 2230 and the RAM 2214, thereby controlling each unit. The graphics controller 2216 obtains image data generated by the CPU 2212 on a frame buffer or the like provided in the RAM 2214 or in itself, and causes the image data to be displayed on the display device 2218.

The communication interface 2222 communicates with other electronic apparatuses via a network. The hard disk drive 2224 stores programs and data used by the CPU 2212 within the computer 2200. The DVD-ROM drive 2226 reads the programs or the data from the DVD-ROM 2201, and provides the hard disk drive 2224 with the programs or the data via the RAM 2214. The IC card drive reads the program and data from an IC card, and/or writes the program and data to the IC card.

The ROM 2230 stores therein a boot program or the like executed by the computer 2200 at the time of activation, and/or a program depending on the hardware of the computer 2200. The input/output chip 2240 may also connect various input/output units to the input/output controller 2220 via a parallel port, a serial port, a keyboard port, a mouse port, and the like.

A program is provided by a computer-readable medium such as the DVD-ROM 2201 or the IC card. The program is read from the computer-readable medium, installed into the hard disk drive 2224, RAM 2214, or ROM 2230, which are also examples of computer-readable medium, and executed by the CPU 2212. The information processing described in these programs is read by the computer 2200 and provides cooperation between the programs and the above-described various types of hardware resources. An apparatus or method may be constituted by realizing the operation or processing of information in accordance with the usage of the computer 2200.

For example, when a communication is executed between the computer 2200 and an external device, the CPU 2212 may execute a communication program loaded in the RAM 2214, and instruct the communication interface 2222 to process the communication on the basis of the processing written in the communication program. The communication interface 2222, under control of the CPU 2212, reads transmission data stored on a transmission buffer processing region provided in a recording medium such as the RAM 2214, the hard disk drive 2224, the DVD-ROM 2201, or the IC card, and sends the read transmission data to a network or writes reception data received from a network to a reception buffer processing region or the like provided on the recording medium.

Moreover, the CPU 2212 may cause all or a necessary portion of a file or a database to be read into the RAM 2214, the file or the database having been stored in an external recording medium such as the hard disk drive 2224, the DVD-ROM drive 2226 (DVD-ROM 2201), the IC card, etc., and execute various types of processing on the data on the RAM 2214. Next, the CPU 2212 writes back the processed data to the external recording medium.

Various types of information, such as various types of programs, data, tables, and databases, may be stored in the recording medium to undergo information processing. The CPU 2212 may execute various types of processing on the data read from the RAM 2214 to write back a result to the RAM 2214, the processing being described throughout the present disclosure, designated by instruction sequences of the programs, and including various types of operations, information processing, condition determinations, conditional branching, unconditional branching, information searches/replacements, or the like. In addition, the CPU 2212 may search for information in a file, a database, etc., in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-described programs or software module may be stored on the computer 2200 or in the computer-readable medium in the vicinity of the computer 2200. Moreover, a recording medium such as a hard disk or RAM provided in a server system connected to a dedicated communication network or the Internet can be used as the computer-readable medium, thereby providing the program to the computer 2200 via the network.

While the present invention has been described by way of the embodiments, the technical scope of the present invention is not limited to the above described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### DESCRIPTION OF REFERENCE NUMERALS

10: system;
20: instrument;
30: processing apparatus;
40: external apparatus;
100: measurement value acquisition unit;
110: state determination estimation unit;
120: selection unit;
130: fluid quality estimation unit;
140: learning processing unit;
150: output unit;
2200: computer;
2201: DVD-ROM;
2210: host controller;
2212: CPU;
2214: RAM;
2216: graphics controller;
2218: display device;
2220: input/output controller;
2222: communication interface;
2224: hard disk drive;
2226: DVD-ROM drive;
2230: ROM;
2240: input/output chip; and
2242: keyboard.

1. An apparatus comprising:
a measurement value acquisition unit which acquires a plurality of measurement values regarding fluid;
a state determination estimation unit which estimates a state of the fluid on a basis of at least one of the plurality of measurement values acquired by the measurement value acquisition unit;
a fluid quality estimation unit which estimates at least one of a liquid amount or dryness regarding the fluid from at least one of the plurality of measurement values acquired by the measurement value acquisition unit according to the state of the fluid estimated by the state determination estimation unit; and
an output unit which outputs the at least one of the liquid amount or the dryness estimated by the fluid quality estimation unit.

2. The apparatus according to claim 1, further comprising
a selection unit which selects a computation corresponding to the state of the fluid estimated by the state determination estimation unit from a plurality of computations, wherein
the fluid quality estimation unit estimates, by the computation selected by the selection unit, the at least one of the liquid amount or the dryness regarding the fluid from at least one of the plurality of measurement values acquired by the measurement value acquisition unit.

3. The apparatus according to claim 1, wherein
the state determination estimation unit estimates whether the state of the fluid is a stratified flow, a stratified wavy flow, or an annular mist flow, on a basis of at least one of the plurality of measurement values acquired by the measurement value acquisition unit.

4. The apparatus according to claim 3, wherein
the state determination estimation unit
determines whether the state of the fluid is wet vapor, on a basis of at least one of the plurality of measurement values acquired by the measurement value acquisition unit, and
if it is determined that the state of the fluid is wet vapor, estimates whether the state of the fluid is a stratified flow, a stratified wavy flow, or an annular mist flow, on a basis of at least one of the plurality of measurement values acquired by the measurement value acquisition unit.

5. The apparatus according to claim 4, wherein
when a measurement value of a temperature of the fluid exceeds a boiling point of the fluid based on a measurement value of a pressure of the fluid acquired by the measurement value acquisition unit, the state determination estimation unit determines that the state of the fluid is not wet vapor, and
if the state determination estimation unit determines that the state of the fluid is not wet vapor, the fluid quality estimation unit estimates that the liquid amount regarding the fluid is 0 or the dryness regarding the fluid is 100%.

6. The apparatus according to claim 1, wherein
the state determination estimation unit estimates the state of the fluid on a basis of at least one of the plurality of measurement values acquired by the measurement value acquisition unit by using a first model for estimating the state of the fluid from at least one of the plurality of measurement values regarding the fluid.

7. The apparatus according to claim 2, wherein
the selection unit selects, according to the state of the fluid estimated by the state determination estimation unit, a second model corresponding to the state of the fluid estimated by the state determination estimation unit from a plurality of second models for estimating the at least one of the liquid amount or the dryness regarding the fluid from at least one of the plurality of measurement values regarding the fluid, and
the fluid quality estimation unit estimates, by using the second model selected by the selection unit, the at least one of the liquid amount or the dryness regarding the fluid from at least one of the plurality of measurement values acquired by the measurement value acquisition unit.

8. The apparatus according to claim 7, further comprising
a learning processing unit which generates, for each state of the fluid, the second model for estimating the at least one of the liquid amount or the dryness regarding the fluid from at least one of the plurality of measurement values regarding the fluid.

9. The apparatus according to claim 1, wherein
the apparatus stores a first model generated by an external learning apparatus for estimating the state of the fluid from at least one of the plurality of measurement values regarding the fluid, and a second model generated by an external learning apparatus for estimating the at least one of the liquid amount or the dryness regarding the fluid from at least one of the plurality of measurement values regarding the fluid according to the state of the fluid estimated by the state determination estimation unit,
the state determination estimation unit estimates, by using the first model, the state of the fluid on a basis of at least one of the plurality of measurement values acquired by the measurement value acquisition unit, and
the fluid quality estimation unit estimates, by using the second model, the at least one of the liquid amount or the dryness regarding the fluid from at least one of the plurality of measurement values acquired by the measurement value acquisition unit.

10. The apparatus according to claim 1, wherein
the measurement value acquisition unit acquires, as the plurality of measurement values regarding the fluid, at least one of a flow velocity, a temperature, a pressure, a viscosity, a concentration, a density, a signal amplitude, or a vortex frequency measured for the fluid.

11. The apparatus according to claim 1, wherein
the measurement value acquisition unit acquires the plurality of measurement values regarding the fluid from a vortex flow meter.

12. A learning apparatus comprising
a learning processing unit which generates, for each state of fluid, a second model for estimating at least one of a liquid amount or dryness regarding the fluid from at least one of a plurality of measurement values regarding the fluid.

13. A method comprising:
acquiring, by a computer, a plurality of measurement values regarding fluid;
estimating, by the computer, a state of the fluid on a basis of at least one of the plurality of measurement values acquired by the computer;
estimating, by the computer, at least one of a liquid amount or dryness regarding the fluid from at least one of the plurality of measurement values acquired by the computer according to the state of the fluid estimated by the computer; and
outputting, by the computer, the at least one of the liquid amount or the dryness estimated by the computer.

14. A non-transitory computer readable medium having recorded thereon a program that causes a computer to function as the apparatus according to claim 1.

15. A non-transitory computer readable medium having recorded thereon a learning program that causes a computer to function as the learning apparatus according to claim 12.

16. The apparatus according to claim 2, wherein
the state determination estimation unit estimates whether the state of the fluid is a stratified flow, a stratified wavy flow, or an annular mist flow, on a basis of at least one of the plurality of measurement values acquired by the measurement value acquisition unit.

17. The apparatus according to claim 2, wherein
the state determination estimation unit estimates the state of the fluid on a basis of at least one of the plurality of measurement values acquired by the measurement value acquisition unit by using a first model for estimating the state of the fluid from at least one of the plurality of measurement values regarding the fluid.

18. The apparatus according to claim 3, wherein
the state determination estimation unit estimates the state of the fluid on a basis of at least one of the plurality of measurement values acquired by the measurement value acquisition unit by using a first model for estimating the state of the fluid from at least one of the plurality of measurement values regarding the fluid.

19. The apparatus according to claim 2, wherein
the measurement value acquisition unit acquires, as the plurality of measurement values regarding the fluid, at least one of a flow velocity, a temperature, a pressure, a viscosity, a concentration, a density, a signal amplitude, or a vortex frequency measured for the fluid.

20. The apparatus according to claim 2, wherein
the measurement value acquisition unit acquires the plurality of measurement values regarding the fluid from a vortex flow meter.
